(19) United States
(12) Patent Application Publication
(10) Pub. No.: US 2011/0260519 A1
(43) Pub. Date: Oct. 27, 2011

(54) PORTABLE AND ADJUSTABLE HEADREST

(76) Inventor: Gregory William Carrigan, SR., St. Peters, MO (US)

(21) Appl. No.: 12/567,775

(22) Filed: Apr. 26, 2010

(51) Int. Cl. A61G 5/12; B60N 2/48; A47C 7/38

(52) U.S. Cl. 297/397

(57) ABSTRACT

A Portable & adjustable Accessory for a 4 wheeled an Accessory that can be fastened to the rear Facing Handles, that enables a user to rest or support there head and neck while sitting in the chair for comfort.

The Accessory has clamps on both sides that adhere to the rear facing handles that can be adjusted to fit several heights and different widths.

### CROSS-REFERENCE TO RELATED APPLICATIONS

This application derives priority from the U.S. non-provisional application Ser. No. 12/576,775 filed Sep. 27, 2009, for the invention of Gregory W. Carrigan Sr, from which priority is claimed.

### STATEMENT REGARDING FEDERALLY SPONSORED RESEARCH

Not Applicable

### BACKGROUND OF THE INVENTION

The invention relates in general to a headrest and, more particularly to a wheelchair, to a process for producing a portable and adjustable headrest

There are no current portable and adjustable headrests that can easily be connected to a standard wheelchair with rear facing handles. A standard wheelchair has no headrest; therefore, it is unable to provide support to a wheelchair bound user. A rear handle wheelchair with side wheels and a chair in which to sit in with leg rest is ideal for this invention.

The headrest is adjustable by height and width and will adjust to the height of 6-10 inches and the width of 16-24 inches.

### Claims

This attachment is for a wheelchair having two large wheels and provides head support for all users. The rear facing handles of a standard wheelchair are utilized in which the headrest is attached to and connected by clamps and supported by the base. The base is adjustable to accommodate the wheelchair by providing a width range of 16-24 inches. The height of the headrest is adjustable by thumbscrews and has a range 0-15 inches.

### SUMMARY

To date, no apparatus is known that could easily equip standard users with this function. It is the precise object of the present invention to provide a piece of additional equipment for a wheelchair designed to provide support for patients or a disabled user. A portable headrest characterizes the invention that is adjusted by height and width to the users. It will be clear that a particularly advantageous variant of the invention a headrest easily clamped to the rear facing handles of a standard wheelchair and is adjustably for various heights and widths.

Among the main characteristics of this type of apparatus are the following: it may be adapted to all existing wheelchairs by means of clamps clamping to the rear facing handles it may be rapidly connected to a chair with the adapters; this operation may be carried out by users themselves by which they enjoy freedom of movement. Otherwise a helper with no special qualifications may carry the operation to ensure rapid, safe restoration of the chair to original position to be useable on all surfaces, including uneven ground additional benefits are this portable adjustable headrest requires no tools to assemble, to attach, or to adjust.

### BRIEF DESCRIPTION OF THE SEVERAL VIEWS OF THE DRAWING

Other characteristics of the invention will emerge from the following description of a particular variant that, although preferred, is no limitative.

The description refers to the attached figures where:

Figure A is a symmetric front view of a standard wheelchair fitted with the apparatus of the invention; the chair is in the usual operating position

Figure B is a symmetric back view identical to the previous showing an intermediate stage in which the wheelchair is fitted with the attachment of the invention

### DETAILED DESCRIPTION OF THE INVENTION

The attachment is capable of easily being fitted to a standard wheelchair to provide support to the user.

In reference to Figure C:

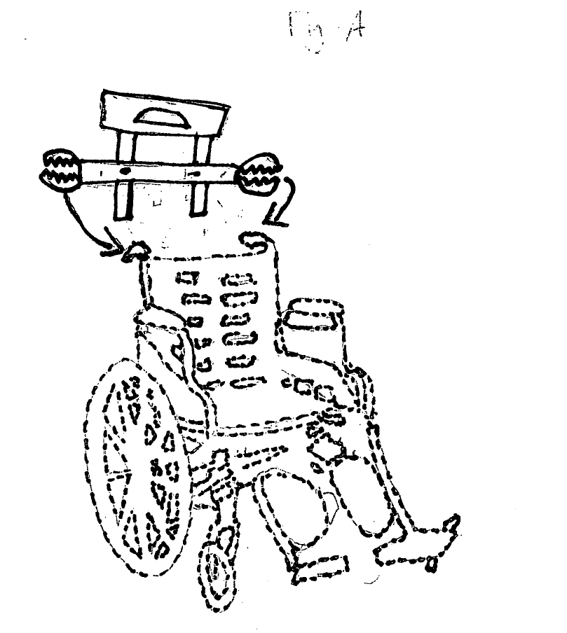

FIG. 3 is a pin hinge attached to FIG. 2 (left side) FIG. 16 (right side) in which makes FIG. 2 and FIG. 16 more extendable for a more stable grip on the rear facing handles.

FIG. 4 (left side) and FIG. 15 (right side) is an adjustable sleeve device that can be adjusted to different sizes to accommodate different widths of wheelchairs.

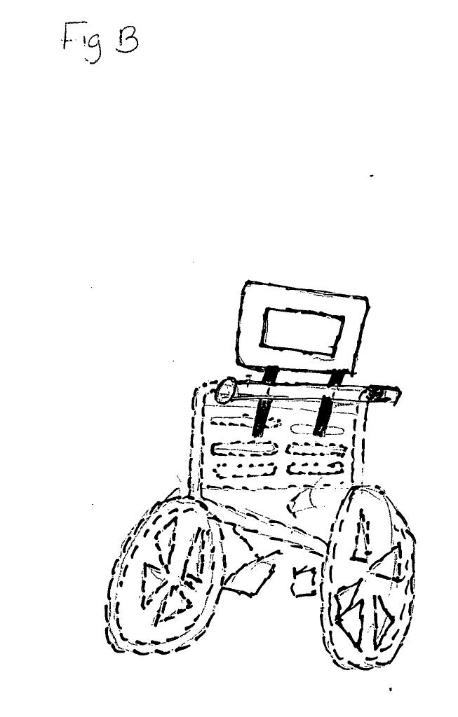

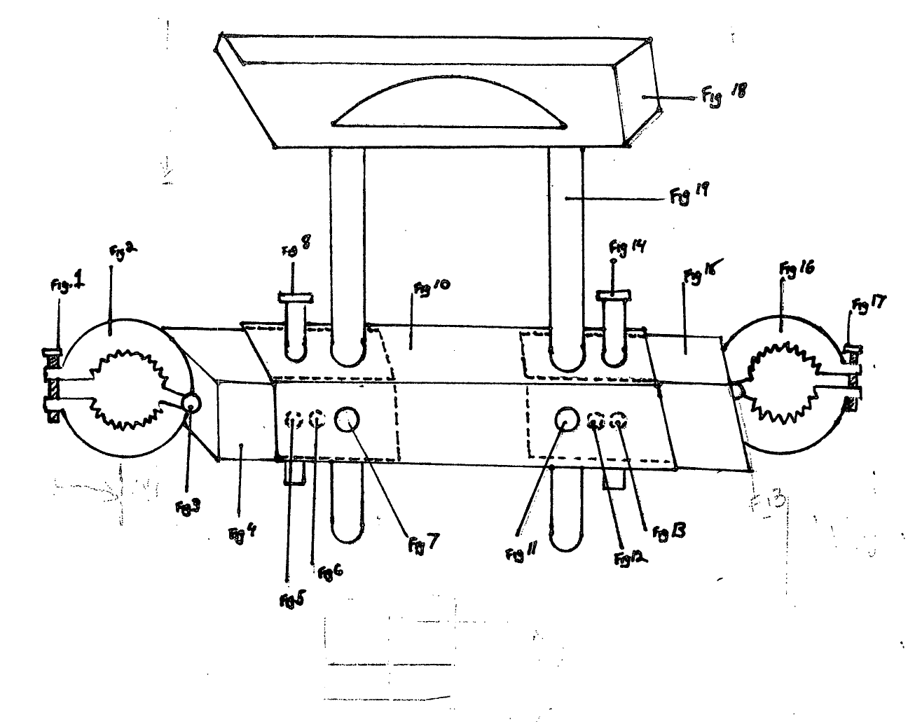

FIG. 5 and FIG. 6 (left side) as well as FIG. 12 and FIG. 13 (right side) are adjustment holes to extend different heights of headrest and to allow FIG. 19 to easily be adjusted horizontally.

What is claimed is:

1. This Accessory can be used with a Four Wheeled Wheel Chair having two large wheels and two small front wheels. This Accessory attaches and clamps down on the rear facing handles to provide comfort and support for the user.

2. The Accessory According to claim 1 is adjustable and portable and is easily attached with no assembly and no tools.

3. The accessory According to claim 2 has locking pins to adjust heights and widths and mounting clamps used to hold the headrest on the rear facing handles for a more secure structure, also the base of the headrest slides out to accommodate wheelchairs 16-24 inches.

4. The accessory According to claim 1. The portable and adjustable headrest accessory is one structured piece with the rest made of foam in a tubular shape having a thickness of roughly 4-5 inches having an overall shape of a rectangle.
